(19) United States
(12) Patent Application Publication
(10) Pub. No.: US 2023/0406574 A1
(43) Pub. Date: Dec. 21, 2023

(54) CURTAIN TYPE FLOWER BASKET HANDLE

(71) Applicant: WEI HE, DONGGUAN CITY, GUANGDONG PROVINCE (CN)

(72) Inventor: WEI HE, DONGGUAN CITY, GUANGDONG PROVINCE (CN)

(21) Appl. No.: 18/271,143

(22) PCT Filed: Jul. 5, 2021
(86) PCT No.: PCT/CN2021/000140

§ 371 Date: Jul. 6, 2023

(30) Foreign Application Priority Data
Jan. 11, 2021 (CN) 202110029403.9

(51) Int. Cl. B65D 25/28; A47G 7/04

(52) U.S. Cl. CPC B65D 25/2879; A47G 7/04; B65D 2525/281

(57) ABSTRACT

A handle for curtain type flower basket is provided. Two frames of the handle, having the same length, are provided, and the two frames are combined together, the two frames (1) sandwich a curtain (2) having one layer, a small flat decoration (3) of a thickness is fittingly connected to a top of the handle, a lower part of the two frames (1) that are combined, that is, an installation part (4) is half a thickness of the frame, installation steps are as follows: 1. directly connecting the handle to the flower basket, 2. connecting the handle to a basket with a shape same as or different from a bottom of the flower basket, and then putting the flower basket in the same basket, and the two frames (1), the curtain (2), the small flat decoration (3) and the flower basket are modified by a variety of modification methods.

### FIELD OF THE DISCLOSURE

The present disclosure relates to the field of decorative flower baskets, buckets, bags and boxes, more specifically to a decorative curtain type flower basket handle.

### BACKGROUND OF THE DISCLOSURE

Since there is a flower basket, there is a flower basket handle provided for the purpose to facilitate people to carry the items in the flower basket. The traditional flower basket handle is simple and practical, and the frame of the handle is mostly composed of a long cylinder or a long flat cylinder or a braid. The body is bent into a symmetrical arc. After many years, the handles of traditional flower baskets have lacked novelty and appear monotonous for decorative flower baskets.

### SUMMARY OF THE DISCLOSURE

The purpose of the present disclosure is to overcome the deficiencies of decorative flower basket handles and provide a handle for curtain type flower basket.

The main point of the present disclosure is as follows. 1. Two frames of the handle for curtain type flower basket are provided, lengths of the two frames are the same, and the two frames are combined together. 2. The two frames sandwich a curtain having one layer. 3. A handheld part is a small flat decoration of a thickness, which is fittingly connected to a top of the handle. 4. A lower part of the combined two frames, that is, an installation part, is half a thickness of each of the two frames. 5. There are two situations for the installation of the handle: a. directly connecting the handle to the flower basket, and b. connecting the handle to a basket with a shape same as or different from a bottom of the flower basket, and then putting the flower basket in the basket. 6. The frames, the curtain, the small decorations, and the flower basket are decorated with various decoration methods, and have patterns formed by various decorations.

Technical solution of the present disclosure is as follows.

A shape of one surface where the two frames of the handle for curtain type flower basket are combined together is selected from the following two situations: 1. the two frames are planes, and 2. a recessed surface and a projected surface are respectively formed by the two frames so as to sandwich the curtain having one layer, a shape of another surface where the two frames are combined together is selected from the following three situations: 1. an arc surface, 2. a plane connection, and 3. a plane and an arc surface are matched and connected; a shape of one surface where the two frames handle are bent is selected from the following two situations: 1. the handle for curtain type flower basket is favorable for manufacture, and has a beautiful appearance with a handle-like symmetrical shape, and 2. the curtain type flower basket handle is favorable for manufacture, and has a beautiful appearance with a handle-like shape, which is helpful for modeling, slightly asymmetrical; the two frames are sculpted and modified for modeling based on the shape thereof; the two frames are based on the basic shape, except for solid, a side facing the flower basket are hollowed out to change from a solid frame to a hollow frame based on the shape of the two frames, which is convenient for installing decorative lights, decorative panels, especially transparent decorative panels.

The main difference between the handle for curtain type flower basket and other handles is that the two frames sandwich the curtain having one layer, and the curtain is installed with the following various types: 1. a soft curtain, 2. a hard curtain, 3. a thin foam plastic curtain, and 4. a mesh curtain, and a shape of the curtain between the two frames is follows: 1. a closing ceremony tile, 2. a closing fold, 3. an opening tiling and 4. a closing titling. The curtain can be modified by various modification methods. The main modification methods of the soft curtain are: printing, embroidery, pasting decorations, and hollowing out. The main modification methods of the hard curtain are: printing, pasting decorations, relief, openwork, and round carving. Emphasis here includes large-area hollow-out carvings in a middle. The main decoration methods for the thin foam plastic curtain are: coloring, pasting decorations, inserting decorations, relief, openwork, and round carving. The main decoration methods for the mesh curtain are: coating flashing paint, hanging lights, and installing lights. The connection method between the curtain and the frame is not emphasized, as long as it can be clamped firmly.

The handheld part at the top is all kinds of small decorative items that are beneficial to the style of the flower basket works, beneficial to the manufacture, and has a beautiful appearance. There are three optional connection methods: 1. pouring together, 2. adhesively, and 3. concave-convex grooves being interlocked, and then nailed firmly. Two optional situations for the decoration beside the small flat decoration are selected: 1. no other decorations are attached, and 2. in order to match a decorative content and style of the small flat decoration, other small decoration items are attached, and a connection method is the same as that of the small flat decorations.

There are various installation methods for the handle, and here are mainly selected from the following methods. 1. magnetic buckle connection, 2. plastic buckle connection, and 3. bolt and nut connection.

When the installation part of the two frames of the handle for curtain type flower basket are connected to the flower basket, the following two situations are selected: 1. all surfaces are flat, and 2. a bottom surface of the basket is decorated with a large-area openwork decoration or a distribution of reinforcing ribs, and sides, including a bottom, are mainly decorated by carving, printing, and pasting decorations.

The meanings of the modification methods mentioned in the present disclosure can be understood as: 1. selecting one from them, and 2. more than one.

The significance of the present disclosure is as follows. 1. A lack of novelty of the traditional flower basket handle is improved. 2. The handle for curtain type flower basket becomes colorful, makes the flower basket icing on the cake and improves the monotony, making people's lives more enjoyable. The handle for curtain type flower basket of the present disclosure is adjustable in production cost and has broad market prospects.

### BRIEF DESCRIPTION OF THE DRAWINGS

FIG. 1 is a schematic structural diagram of the present disclosure.

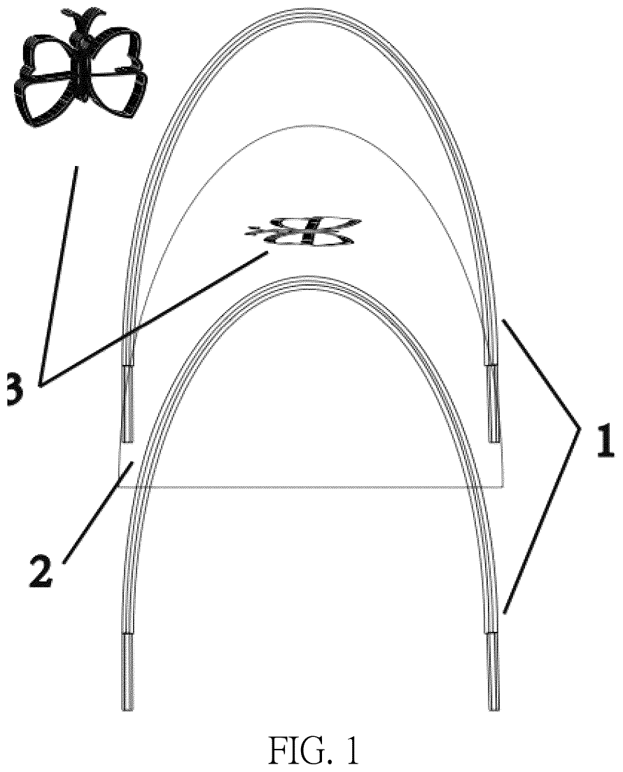

FIG. 2 is a schematic diagram of the handle for flower basket of the present disclosure in a closing ceremony.

FIG. 3 is a schematic diagram of the handle for flower basket of the present disclosure in an opening ceremony.

FIG. 4 is a schematic diagram of the handle for flower basket of a large-area openwork in a middle of the present disclosure.

FIG. 5 is a schematic diagram of the handle for curtain type flower basket with a basket at a bottom of the present disclosure.

### DETAILED DESCRIPTION OF THE EXEMPLARY EMBODIMENTS

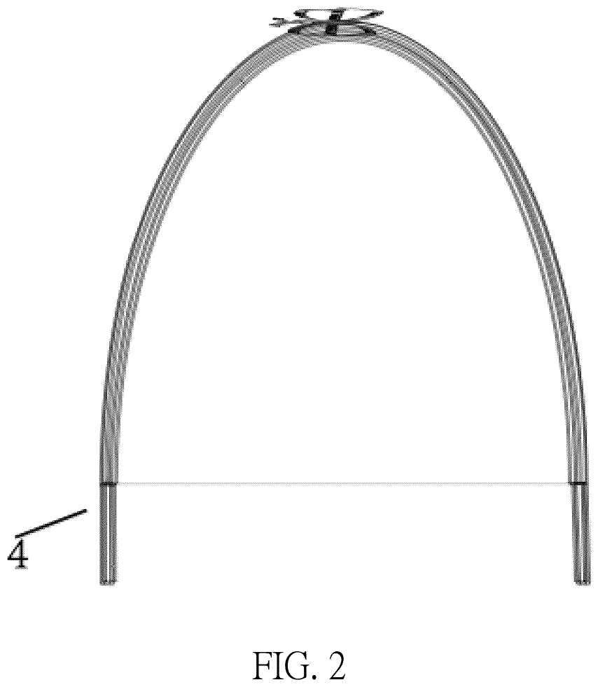

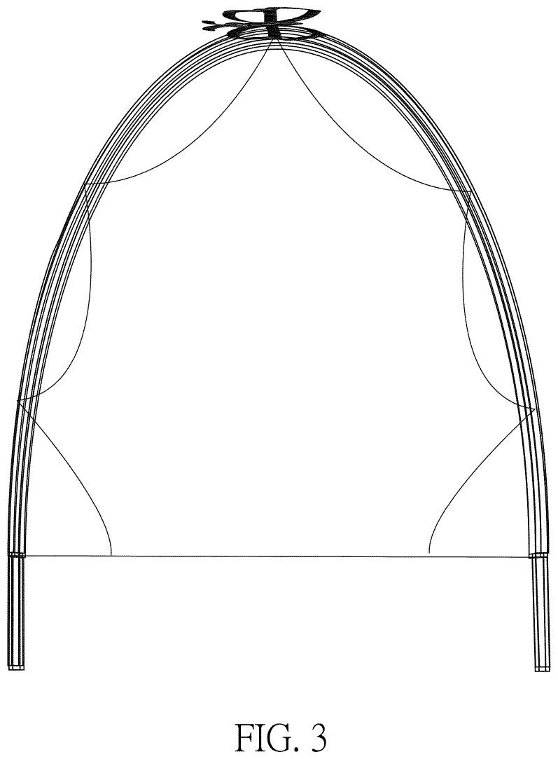

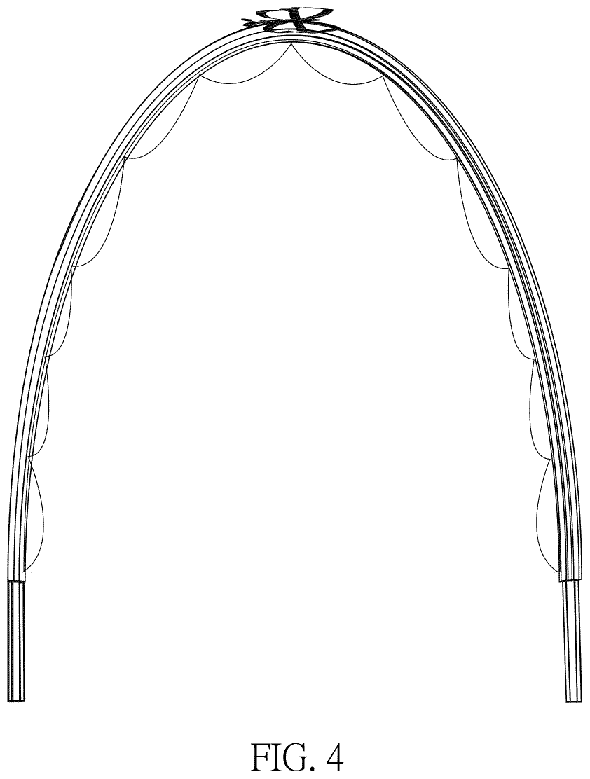

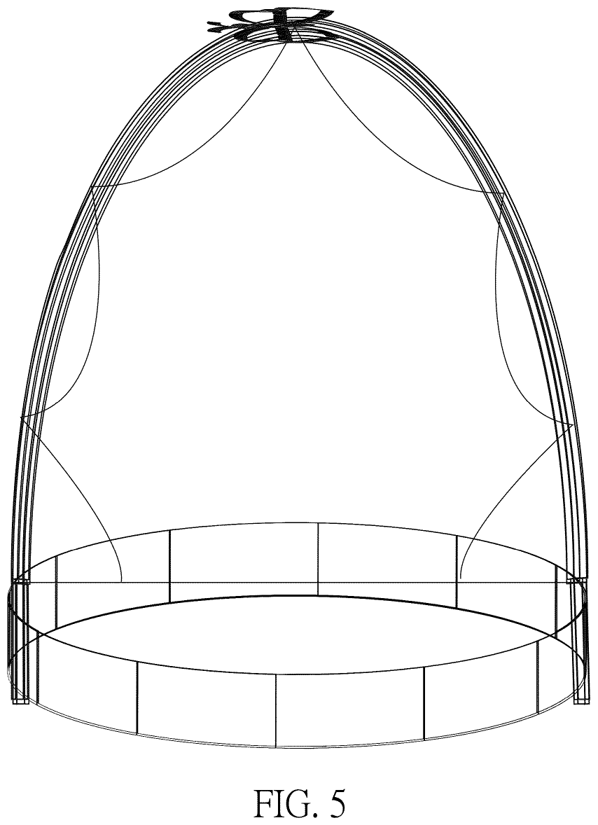

Reference is made to the figures, in which two frames 1 sandwich a curtain 2, a small flat decoration 3 is laid flat on a back, matching a top of the handle, and an installation part 4 that is a lower part of the handle is half a thickness of the two frames 1. A state that the handle is directly connected to a basket is correspondingly shown in FIG. 2, FIG. 3, and FIG. 4. A state of the handle with the basket is shown in FIG. 5. There are various connection methods for the installation part, which will be omitted herein.

1. A handle for curtain type flower basket, wherein two frames of the handle for curtain type flower basket are provided, lengths of the two frames are the same, and the two frames are combined together; the two frames (1) sandwich a curtain (2) having one layer; a small flat decoration (3) of a thickness, that is, an handheld part, is fittingly connected to a top of the handle; a lower part of the two frames (1) that are combined, that is, an installation part (4) is half a thickness of each of the two frames, installation steps are as follows: 1. directly connecting the handle to the flower basket, and 2. connecting the handle to a basket with a shape same as or different from a bottom of the flower basket, and then putting the flower basket in the basket, and the two frames (1), the curtain (2), the small flat decoration (3), and the flower basket are modified by a variety of modification methods.

2. The handle for curtain type flower basket according to claim 1, wherein a shape of one surface where the two frames of the handle for curtain type flower basket are combined together is selected from the following two situations: 1. the two frames are planes, and 2. a recessed surface and a projected surface are respectively formed by the two frames so as to sandwich the curtain having one layer, a shape of another surface where the two frames are combined together is selected from the following three situations: 1. an arc surface, 2. a plane connection, and 3. a plane and an arc surface are matched and connected; a shape of one surface where the two frames are bent is selected from the following two situations: 1. the handle for curtain type flower basket is favorable for manufacture, and has a beautiful appearance with a handle-like symmetrical shape, and 2. the handle for curtain type flower basket is favorable for manufacture, and has a beautiful appearance with a handle-like shape, which is helpful for modeling, slightly asymmetrical; the two frames (1) are sculpted and modified for modeling based on the shape thereof; the two frames (1) are based on the basic shape, except for solid, a side facing the flower basket are hollowed out to change from a solid frame to a hollow frame based on the shape of the two frames (1), which is convenient for installing decorative lights, decorative panels, especially transparent decorative panels.

3. The handle for curtain type flower basket according to claim 1, wherein a main point of the curtain type flower basket handle is that the two frames (1) sandwich the curtain (2) having one layer, and the curtain (2) is installed with the following various types: 1. a soft curtain, 2. a hard curtain, 3. a thin foam plastic curtain, and 4. a mesh curtain; a shape of the curtain between the two frames (1) is as follows: 1. a closing ceremony tile, 2. a closing fold, and 3. an opening tiling.

4. The handle for curtain type flower basket according to claim 1, wherein, when the installation part (4) of the two frames (1) of the handle is connected to the basket, the following two situations are selected: 1. all surfaces of the basket are flat, and 2. a bottom surface of the basket is decorated with a large-area openwork decoration or a distribution of reinforcing ribs, and sides, including a bottom, are mainly decorated by carving, printing, and pasting decorations.

5. The handle for curtain type flower basket according to claim 1, wherein two optional situations for the decoration beside the small flat decoration (3) are selected: 1. no other decorations are attached, and 2. in order to match a decorative content and style of the small flat decoration (3), other small decoration items are attached, and a connection method is the same as that of the small flat decoration (3).
